(19) United States
(12) Patent Application Publication
(10) Pub. No.: US 2008/0047621 A1
(43) Pub. Date: Feb. 28, 2008

(54) Check Valve

(76) Inventors: Ralph Ittlinger, Weissach (DE); Andreas Peetz, Ludwigsburg (DE); Werner Haarer, Illingen (DE); Goekhan Yerlikaya, Oberriexingen (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/659,843

(22) PCT Filed: Aug. 5, 2005
(86) PCT No.: PCT/EP05/53863

§ 371 Date: Feb. 9, 2007

(30) Foreign Application Priority Data
Aug. 13, 2004 (DE) 10 2004 039 297.8
Oct. 6, 2004 (DE) 10 2004 048 593.3

(51) Int. Cl. F16K 15/04

(52) U.S. Cl. 137/539

(57) ABSTRACT

In the check valve according to the invention, the wear on the valve closure member is reduced in that after the opening of the check valve, the closure member assumes a position that is spaced sufficiently apart from the valve seat. A region with a constant throttle gap is provided upstream of the throttle-reduction region.

### PRIOR ART

The invention is based on a check valve as generically defined by the preamble to the main claim.

DE 195 07 321 C2 has already disclosed a check valve, having a closure member that cooperates with a valve seat, has a maximum diameter at its widest point, and is situated in an axially movable fashion in a valve chamber, and having a throttle gap between a wall of the valve chamber and the widest point of the closure member; the wall of the valve chamber is embodied in such a way that the throttle gap widens out conically in a throttle-reduction region as the closure member executes a stroke in the direction oriented away from the valve seat. As the stroke increases in the opening direction, the throttle gap is continuously enlarged so that the motive force exerted on the closure member decreases as the stroke increases in the opening direction. It is disadvantageous that the enlargement of the throttle gap begins immediately after the closure member lifts away from the valve seat and the closure member therefore executes only a comparatively small stroke with a small distance from the valve seat. Under unfavorable operating conditions, for example when cold starting an internal combustion engine or when hot fuel is supplied, an oscillation of the closure member can occur. As a result of the small distance between the closure member and the valve seat, the oscillating motion of the closure member can cause it to strike against the valve seat at a high oscillation frequency so that a high level of wear on the closure member occurs and unpleasant noise is generated.

### ADVANTAGES OF THE INVENTION

The check valve according to the invention, with the characterizing features of the main claim, has the advantage over the prior art of achieving, through simple means, an improvement in that the wear on the closure member is reduced through the provision of a region with a constant throttle gap upstream of the throttle-reduction region. In this manner, when the check valve is open, the closure member is brought into a position that is a greater distance from the valve seat, thus preventing a collision of the closure member with the valve seat and the wear that this would cause. This also prevents the generation of unpleasant noise. The greater distance from the valve seat also makes the check valve less sensitive to contamination.

Advantageous modifications and improvements of the check valve disclosed in the main claim are possible by means of the measures taken in the dependent claims.

It is particularly advantageous if the throttle gap widens out in stepped fashion or continuously in the throttle-reduction region. According to an advantageous embodiment, the wall of the valve chamber in the throttle-reduction region has a step-shaped shoulder or a conical expansion. In comparison to the continuous expansion, the step-shaped shoulder has the advantage of achieving flatter curves of the pressure loss and stroke over the flow.

It is also advantageous if the closure member has a closing section that cooperates with the valve seat and, adjoining the closing section, has a cylindrical section and/or a guide section since as a result, the closure member takes up a particularly small amount of space.

It is very advantageous if the widest point of the closure member is provided in the closing section or in the cylindrical section since this is particularly flow-promoting.

It is also advantageous if the circumference of the valve chamber is provided with a number of ribs extending in the axial direction in relation to a valve axis since this provides the closure member with a particularly favorable axial guidance.

It is also advantageous if the ribs have a varying width measured in the circumference direction of the valve chamber since this achieves an asymmetrical circulation around the closure member, which damps the oscillation behavior of the closure member.

According to another advantageous embodiment, an asymmetrical flow circulation around the closure member is achieved by embodying the closure member asymmetrically at its widest point and, for example, providing it with a flattened region.

### DRAWINGS

Exemplary embodiments of the invention are shown in simplified fashion in the drawings and will be explained in detail in the description that follows.

FIG. 1 shows a sectional view of a first exemplary embodiment of the check valve according to the invention,

FIG. 2 shows a view of a second exemplary embodiment,

FIG. 3 shows a first characteristic curve, and

FIG. 4 shows a second characteristic curve of the check valve according to the invention.

### DESCRIPTION OF THE EXEMPLARY EMBODIMENTS

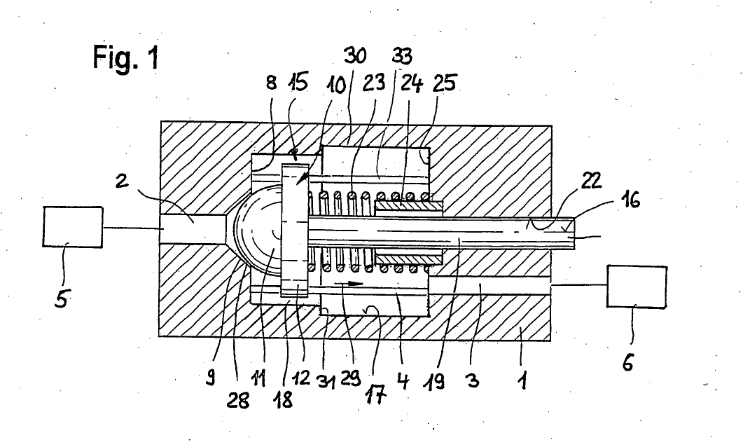

FIG. 1 shows a sectional view of a first exemplary embodiment of the check valve according to the invention.

A fluid can pass through the check valve according to the invention only in one flow direction. It can therefore be used, for example, in a fuel supply unit of an internal combustion engine, which usually includes a delivery unit. The delivery unit supplies the internal combustion engine with pressurized fuel. For this use, the check valve is situated between the delivery unit and the engine and, when the delivery unit is switched off, prevents fuel from flowing back from the engine to the delivery unit. This maintains the fuel pressure in the engine. But the check valve can implicitly also be used in other supply units to prevent a reflux of any kind of fluid.

The check valve according to the invention has a valve housing 1 with an inlet conduit 2 and an outlet conduit 3 that both open out into a for example cylindrical valve chamber 4. The inlet conduit 2 is flow-connected for example to a delivery unit 5 and the outlet conduit 3 is flow-connected to an internal combustion engine 6. At its end oriented toward the valve chamber 4, the inlet conduit 2 has a valve seat 9 that is embodied, for example, as conical or spherical. The valve seat 9 is situated, for example, at a first end 8 of the valve chamber 4.

A closure member 10 that cooperates with the valve seat 9 is situated in the valve chamber 4 in an axially movable fashion. For example, the closure member 10 has a closing section 11, which is oriented toward the valve seat 9 and can be adjoined by a cylindrical section 12 in the direction oriented away from the valve seat 9. For example, the closing section 11 is embodied in the form of a sphere, a sphere segment, or a cone. For example on the side oriented toward the valve seat 9, the closing section 11 is at least partially manufactured out of the rubber, but can also be made of plastic or metal. For example, the valve housing 1 with the valve seat 9 is manufactured out of a plastic or metal. The closure member 10 has a widest point 15 that has a maximum radial span, for example a maximum diameter, in relation to a valve axis 16 of the check valve. The widest point 15 is provided, for example, in the closing section 11 or in the cylindrical section 12. In the radial direction between the widest point 15 and a wall 17 of the valve chamber 4, a for example annular throttle gap 18 is formed, which dams up the fluid flowing through the check valve in order to achieve the greatest possible opening force acting on the closure member 10.

For example, the cylindrical section 12 is embodied as the widest point 15 and has a greater radial span in relation to the valve axis 16 than the closing section 10. The edges of the cylindrical section 12 can be embodied as beveled or rounded. In addition, the circumference surface of the cylindrical section 12 can be provided with a radius. In this way, the throttling action of the widest point 15 is embodied as particularly flow-promoting.

The end of the closing section 11 or cylindrical section 12 oriented away from the valve seat 9 is adjoined, for example, by a guide section 11, which is embodied, for example, in the form of a shaft or cylinder and is guided in a guide conduit 22 of the valve housing 1. The guide conduit 22 opens out into the valve chamber 4.

A return spring 23 acts on the closure member 10 in the direction toward the valve seat 9. The return spring 23 is embodied, for example, in the form of a helical spring and is situated around the guide section 19. One end of the return spring 23 rests, for example, against the closing section 11 or against the cylindrical section 12 and the other end rests against the wall 17 of the valve chamber 4.

The closure member 10 is supported in the valve chamber 4 so that it can move axially between the valve seat 9 and a stop 24 that functions as a stroke limiter. For example, the stop 24 is embodied in the form of a sleeve 24 that encompasses the guide section 19 in annular fashion and is situated, for example, radially inside the return spring 23. The sleeve 24 is provided, for example, at an end 25 of the valve chamber 4 oriented away from the valve seat 9, with its axial span protruding into the valve chamber 4. The sleeve 24 can also be integrally joined to the valve housing 1 and the stop 24 can be embodied at the circumference of the valve chamber 4.

For example, the inlet conduit 2 with the valve seat 9, the valve chamber 4, the closure member 10, the guide conduit 22, the return spring 23, and the stop 24 are situated concentrically in relation to the valve axis 16.

The pressure of the fluid, for example the fuel, generated by the delivery unit 5 acts on the closure member 10 via the inlet conduit 2. If the pressure upstream of the valve seat 9 exceeds a value that depends on the spring force of the return spring 23, then the closure member 10 lifts away from the valve seat 9, thus opening the check valve. After the check valve has opened, the fluid flows via the inlet conduit 5 and an inlet gap 28 between the valve seat 9 and the closing section 11 of the closure member 10, into the valve chamber 4, circulates around the closing section 11, flows through the throttle gap 18, and exits the valve chamber 4 via the outlet conduit 3, for example in the direction toward the internal combustion engine 6. The fluid flowing into the valve chamber 4 exerts a motive force on the closing section 11 of the closure member 10, moving the latter farther in the direction oriented away from the valve seat 9, counter to the spring force of the return spring 23 until an equilibrium of forces is achieved. The motive forces of the flow increase as the flow through the check valve increases. The spring force of the returning spring 23 increases linearly as the stroke of the closure member 10 increases.

When the delivery unit 5 is switched off, the pressure in the inlet conduit 2 drops sharply and the spring force of the return spring 23, combined with the compressive force of the still pressurized fluid downstream of the closure member 10 acting on the closure member 10 in the direction toward the valve seat 9, moves the closure member 10 toward the valve seat 9 so that the valve closes, preventing a reflux of fluid from the valve chamber 4 or from further downstream, in the direction toward the inlet conduit 2.

The total pressure loss of the check valve is essentially comprised of the pressure loss at the inlet gap 28 and the pressure loss of the throttle gap 18. The pressure loss at the inlet gap 28 decreases as the inlet gap 28 becomes larger, i.e. with an increasing stroke of the closure member 10 in an opening direction 29. By contrast, the pressure loss at the initially constant throttle gap 18 increases as the flow increases.

At the circumference of the valve chamber 4, the wall 17 of the valve chamber 4 has a throttle-reduction region 30 in which the valve chamber 4 expands continuously or in a stepped fashion, radially in relation to the valve axis 16 in the direction oriented away from the valve seat 9. For example, the wall 17 of the valve chamber has a step-shaped shoulder 31 at its circumference. The step-shaped shoulder 31 can, for example, be provided with a bevel or a radius.

During a stroke in the opening direction 29, when the widest point 15 of the closure member 10 reaches the throttle-reduction region 30, the throttle gap 18 increases in size, for example in a step-shaped fashion when a step-shaped shoulder 31 is provided. In this way, the pressure loss at the throttle gap 18 and the motive force acting on the closure member 10 are reduced in stepped fashion.

The motive force that the flow exerts on the closure member 10 increases as the flow increases and as the throttle gap 18 decreases. The greater the motive force, the greater the stroke of the closure member 10 and thus the greater the distance of the closure member 10 from the valve seat 9.

According to the invention, upstream of the throttle-reduction region 30, a region with a constant throttle gap 18 is provided so that as it executes a stroke in the direction oriented away from the valve seat 9, the widest point 15 of the closure member 10 passes in the stroke direction through a region with a constant throttle gap 18 before reaching the throttle-reduction region 30. As a result, the closure member 10 is subjected to a powerful motive force immediately after the closure member 10 lifts away from the valve seat 9, thus executing a large stroke and assuming a position that is a sufficient distance from the valve seat 9. This also results in fewer dirt particles getting caught in the inlet gap 28 and hindering the return movement toward the valve seat 9 in a subsequent closing so that the check valve according to the invention is less sensitive to dirt particles in the fluid. The embodiment according to the invention prevents the closure member from striking against the valve seat 9 when the closure member 10 oscillates and thus prevents it from causing wear on the valve seat 9. The oscillation of the closure member 10 is essentially caused by slight changes in the volumetric flow of the delivery unit 5 and/or by pressure fluctuations downstream of the check valve. The volumetric flow of the delivery unit 5 can, for example, decrease under unfavorable operating conditions when the delivery unit only receives a reduced electrical voltage from the voltage source, which can occur, for example, when cold starting the internal combustion engine. A reduction in the volumetric delivery flow can also be caused by intensely heated fuel that contains vapor bubbles in the fuel. The throttle gap 18 in the region with the constant throttle gap 18 is embodied to be as small as possible.

For example, the circumference of the valve chamber 4 is provided with a number of ribs 33 extending in the axial direction in relation to the valve axis 16. For example, the ribs 33 are distributed uniformly around the circumference of the valve chamber 4 and serve to guide the closure member 10.

To further reduce the oscillation of the closure member 10, it is possible to generate a force that acts on the closure member 10 transversely in relation to the valve axis 16, thus producing an increased friction and damping in the closure member guidance, for example in the guide conduit 22. This transverse force is produced with an asymmetrical circulation around the closure member 10, which is achieved by means of an asymmetrical embodiment of the closure member 10 or the wall 17 of the valve chamber 4 encompassing the closure member 10. For example, the closure member 10 can be provided with a flattened region in order to generate the asymmetrical circulatory flow or the ribs 33 can have a varying width measured in the circumference direction.

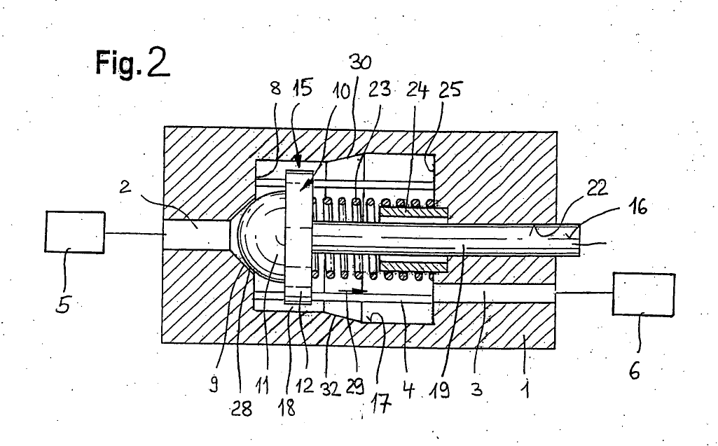

FIG. 2 shows a sectional view of a second exemplary embodiment of the check valve according to the invention.

In the check valve in FIG. 2, parts that remain the same or are functionally equivalent to those in the check valve according to FIG. 1 have been provided with the same reference numerals.

The check valve according to FIG. 2 differs from the check valve according to FIG. 1 in that the throttle reduction region 30 is embodied not as stepped, but as conical. In lieu of the step-shaped shoulder 31, a conical expansion 32 of the valve chamber 4 in the opening direction 29 is provided.

During a stroke in the opening direction 29, when the widest point 15 of the closure member 10 reaches the throttle-reduction region 30, the throttle gap 18 according to the second exemplary embodiment increases in size continuously as the stroke increases. In this fashion, the pressure loss at the throttle gap 18 and the motive force acting on the closure member 10 are reduced in continuous fashion.

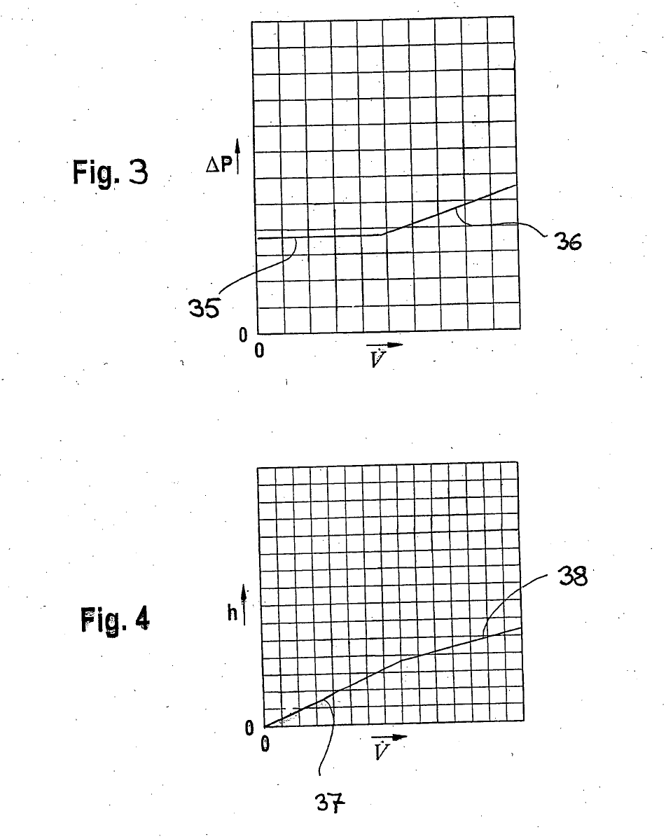

FIG. 3 shows a characteristic curve of the check valve according to the invention, with the total pressure loss ΔP plotted on the ordinate and the volumetric flow or through-flow \dot{V} plotted on the abscissa.

The total pressure loss of the check valve after the opening of the check valve remains virtually constant in the direction of increasing flow in a first curve segment 35 since the decrease in the pressure loss at the inlet gap 28 and the increase in the pressure loss at the throttle gap 18 approximately cancel each other out as the flow and stroke increase.

In a second curve segment 36 that adjoins the first curve segment 35 in the direction of increasing flow, the total pressure loss increases linearly, but with a more gradual slope than in a check valve without a throttle-reduction region. In the second curve segment 36, the total pressure loss increases because the decrease in the pressure loss at the inlet gap 28 is still only very slight. Since the increase in the pressure loss in the throttle-reduction region 30 is reduced by the enlargement of the throttle gap 18, the increase in the total pressure loss in the second curve segment 36 is less pronounced than in a check valve without a throttle-reduction region. Consequently, the check valve according to the invention has a comparatively slight pressure loss at a high flow rate. In comparison to the continuous expansion 32 in the throttle-reduction region 30, the step-shaped expansion 31 has the advantage of achieving a flatter curve of the total pressure loss in the second curve segment 36.

FIG. 4 shows a characteristic curve of the check valve according to the invention, with the stroke h plotted on the ordinate and the volumetric flow or through-flow \dot{V} plotted on the abscissa.

Due to the constant throttle gap 18, in a first curve segment 37, as the flow increases, the stroke of the closure member 10 increases with a comparatively steep slope. The throttle-reduction region 30 reduces the steep increase in the stroke curve so that in a second curve segment 38, as the volumetric flow increases, the stroke increases with a more gradual slope than before.

Whereas the stroke curve is parabolic in a check valve without an expansion of the throttle gap, the check valve according to the invention with the step-shaped or conical expansion of the throttle gap 18 executes a virtually linear stroke curve. The first curve segment 37 and the second curve segment 38 are therefore embodied as at least approximately linear. The stroke of the closure member 10 of the check valve according to the invention is influenced by the axial position of the step-shaped shoulder 31 or the continuous expansion 32 in relation to the valve axis 16 so that it is possible to optimize the linear stroke curve by varying the axial position of the step-shaped shoulder 31 or the continuous expansion 32.

The axial position of the step-shaped shoulder 31 or the continuous expansion 32 in relation to the valve axis 16 is selected, for example, in such a way that in the second curve segment 38, the closure member 10 assumes a stable position in which only slight oscillations occur and a slight pressure loss occurs at a high flow rate.

The transition from the first curve segment 37 to the second curve segment 38 is determined by the axial position of the step-shaped shoulder 31 or the continuous expansion 32 in relation to the valve axis 16. As soon as the closure member 10 reaches the throttle-reduction region with the step-shaped shoulder 31 or the continuous expansion 32, the stroke characteristic curve continues flatter than before. Since the closure member 10 executes only a small stroke in the second curve segment 38, it does not reach the stop 44, for example. This has the advantage that the closure member 10 cannot transmit any noise to the valve housing 1 via the stop 24. But if the closure member 10 reaches the maximum stroke and strikes against the stop 24, the linearly rising second curve segment 38 transitions into a horizontally extending region that is not shown.

If the check valve is in an operating point of the second curve segment 38, then slight changes in the flow result in an only slight stroke change in comparison to the first curve section segment 37 so that the closure member 10 assumes a comparatively stable position.

In comparison to the continuous expansion 32, the step-shaped expansion 31 in the throttle-reduction region 30 has the advantage of achieving a flatter curve of the stroke, plotted over the volumetric flow, in the second curve segment 38.

1-11. (canceled)

12. A check valve, comprising a closure member which cooperates with a valve seat, the closure member having a maximum diameter at a widest point and being situated in an axially movable fashion in a valve chamber, a throttle gap between a wall of the valve chamber and the widest point of the closure member, in which throttle gap the wall of the valve chamber is embodied in such a way that as the closure member executes a stroke in the direction oriented away from the valve seat, the throttle gap expands in a throttle-reduction region, and a region with a constant throttle gap upstream of the throttle-reduction region.

13. The check valve according to claim 12, wherein the throttle gap expands in stepped fashion or continuously in the throttle-reduction region.

14. The check valve according to claim 13, wherein the wall of the valve chamber in the throttle-reduction region has a step-shaped shoulder or a conical expansion.

15. The check valve according to claim 14, wherein the axial position of the step-shaped shoulder or of the conical expansion in relation to a valve axis is selected so as to yield a substantially linear curve of the stroke over the flow.

16. The check valve according to claim 12, wherein the closure member comprises a closing section that cooperates with the valve seat.

17. The check valve according to claim 16, wherein the closure member comprises a cylindrical section and/or a guide section adjoining the closing section.

18. The check valve according to claim 17, wherein the widest point of the closure member is provided in the closing section or in the cylindrical section.

19. The check valve according to claim 12, wherein the circumference of the valve chamber is provided with a number of ribs extending in the axial direction in relation to a valve axis.

20. The check valve according to claim 19, wherein the ribs have a varying width measured in the circumferential direction of the valve chamber.

21. The check valve according to claim 12, wherein the closure member is embodied asymmetrically at its widest point.

22. The check valve according to claim 21, wherein the closure member has a flattened region at its widest point.
